(19) United States
(12) Patent Application Publication
(10) Pub. No.: US 2006/0216070 A1
(43) Pub. Date: Sep. 28, 2006

(54) Casing for transporting a toner mixture and method for producing a casing of this type

(76) Inventors: Martin Zehentbauer, Gauting (DE); Herbertu Heimpoldinger, Ampfing (DE); Thomas Schwarz-Kock, Marzling (DE)

Correspondence Address: SCHIFF HARDIN, LLP;PATENT DEPARTMENT, 6600 SEARS TOWER, CHICAGO, IL, 60606-6473, US

(21) Appl. No.: 10/560,969

(22) PCT Filed: Jun. 25, 2004
(86) PCT No.: PCT/EP04/06927

§ 371 Date: Apr. 7, 2006

(30) Foreign Application Priority Data
Jun. 26, 2003 (DE) 103 28 857.0

(51) Int. Cl. G03G 15/09

(52) U.S. Cl. 399/276

(57) ABSTRACT

A casing is provided for transport of a toner mixture on its outer surface in a development device. An outer surface of a metal casing is chemically pre-treated. In a subsequent chemical deposition, a nickel-copper-phosphor layer is generated on the outer metal casing surface. The layer comprises 1 to 2% copper and 8 to 10% phosphor and the remainder comprises substantially nickel.

### BACKGROUND

The preferred embodiment concerns a casing for transport of a toner mixture on its outer surface in a toner development device, whereby the wall of the casing is substantially comprised of an electrically-conductive material. The preferred embodiment also concerns a method for production of such a casing.

In electrographic printer or copiers, image development methods are used that develop the electrostatic charge images on surfaces (advantageously on photoconductor surfaces) via an air gap or in direct contact with triboelectrically charged toner. The toner is frequently executed as a two-component mixture made from toner particles and ferromagnetic carrier particles. This two-component mixture is transported with the aid of a casing on its surface, whereby this casing internally contains magnets whose magnetic field, with the aid of carrier particles, forms a magnetic brush on the surface of the casing that transports the toner particles.

A casing for a toner development device on whose surface a two-component mixture is transported is described from DE-A-2846430. In this document, it is viewed as a disadvantage that conventional casings use aluminum as a material in which eddy currents are generated due to the varying magnetic field, which eddy currents effect a heating of the toner material and its softening. It is therefore proposed there to use a material with a high electrical resistance in order to reduce the eddy current effect. The casing is accordingly produced from a copper-nickel alloy and the generated surface of the casing is provided with grooves parallel to the axis.

Furthermore, casings for transport of a toner mixture are also used in cleaning devices within a developing device. DE-A-10152892 gives an example for this.

JP 03-041485 A with abstract, U.S. Pat. No. 6,201,942 B1, DE 33 03 167 A1 and EP 0 800 336 A1 are as further prior art.

In practice, aluminum is conventionally used as a casing material. However, aluminum has the disadvantage that it is a relatively soft material whose surface wears in the course of time in printing operation. It can thereby lead to quality losses in the print image. In order to provide the surface of the casing with a harder material, it was proposed to provide the aluminum casing with a nickel layer on its surface. This does in fact have the desired effect with regard to the hardness, however the electrical resistance of the entire casing is hereby altered, which leads to a negative influencing of the electromagnetic properties on the surface of the casing.

A further problem in transport casings for toner is the oxidation on the transport surface. Given aluminum casings, aluminum oxide can form on the surface. The oxide layer likewise alters the properties of the casing material, for example the electrical resistance, and thus the electromagnetic parameters at the connection point of casing and photoconductor drum.

### SUMMARY

It is an object to specify a casing for transport of a toner mixture and a method for production of a casing, whereby important electromagnetic and mechanical properties are achieved for the function.

A casing is provided for transport of a toner mixture on its outer surface in a development device. An outer surface of a metal casing is chemically pre-treated. In a subsequent chemical deposition, a nickel-copper-phosphor layer is generated on the outer metal casing surface. The layer comprises 1 to 2% copper and 8 to 10% phosphor and the remainder comprises substantially nickel.

### BRIEF DESCRIPTION OF THE DRAWINGS

FIG. 1 shows a hollow cylindrical casing for transport of toner; and

FIG. 2 and FIG. 3 illustrate method steps for production of the surface layer for the casing made from aluminum.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

With the preferred embodiment a casing of the previously cited type is provided wherein in that the outer surface of the casing receives a layer made of nickel-copper. On the one hand this alloy layer has the required hardness and thus a lower abrasion, so that a higher usage duration results. On the other hand, such a layer has a high electrical conductivity, whereby advantageous electromagnetic properties result. The electrical resistance of this layer can be optimized via adjustment of the alloy ratios. Such an alloy layer can only be slightly magnetized or not magnetized at all, such that a disadvantageous residual magnetism is avoided. The combination of high electrical conductivity and high hardness leads to the situation that previous aluminum casings can be exchanged for the casing of the preferred embodiment without electromagnetic or mechanical parameters being changed to a great extent. An oxidation of the surface is avoided due to the alloy layer.

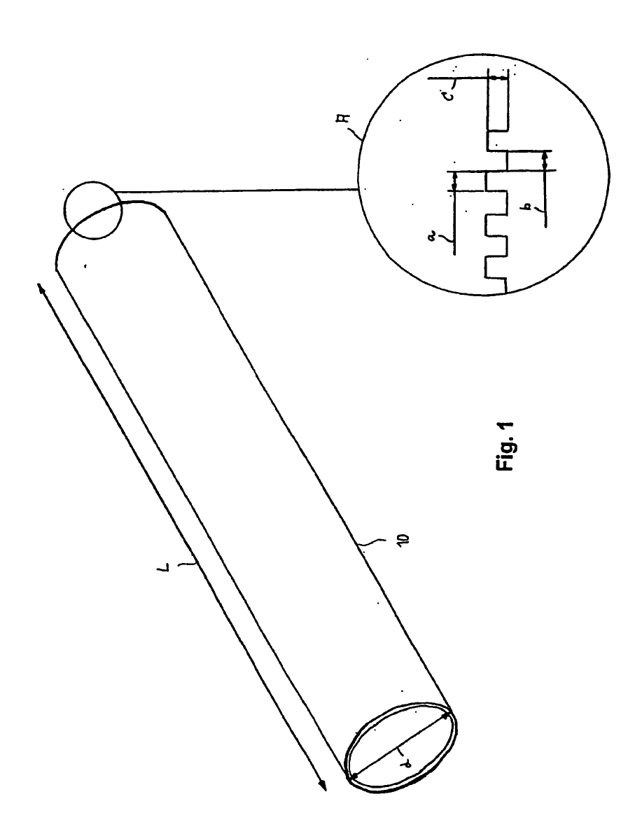

FIG. 1 shows a cylindrical casing 10 with a surface section A. Such a casing 10 can, for example, have a length L of 500 mm, an external diameter d of 60.5 mm, and an inner diameter of 56 mm. As is shown in the surface section A, the surface can have a groove structure with the parameters a=0.45±0.05 mm, b=0.62±0.05 mm and c=0.5±0.2 mm. The transport behavior of the surface of the casing 10 is improved with aid of this groove structure.

The casing 10 is advantageously comprised of aluminum and bears a layer made of nickel-copper on its outer surface having a thickness in a range of 15 to 25 μm. This layer is generated via chemical deposition, whereby a chemical nickel-copper-phosphor deposition occurs. The layer typically contains 1 to 2% copper and 8 to 10% phosphor, whereby the remainder is nickel deposition.

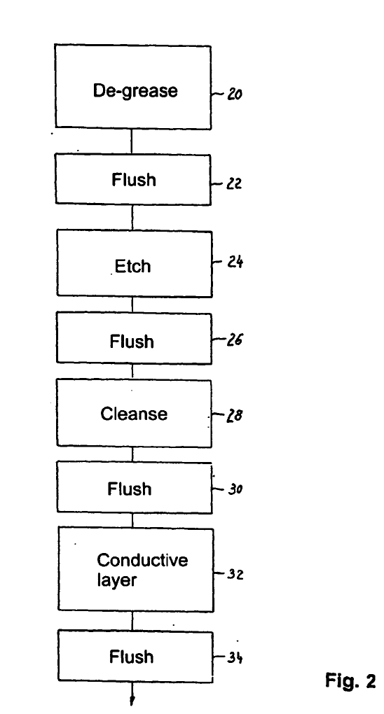

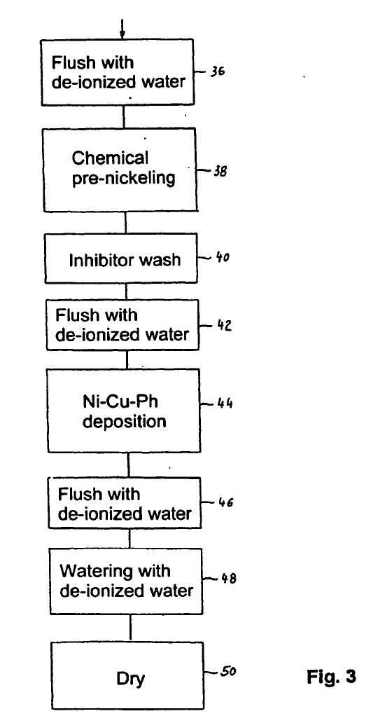

Using a workflow diagram, FIGS. 2 and 3 show the chemical surface treatment for generation of the casing with the nickel-copper layer. The aluminum casing is initially degreased in alkaline solution (step 20). A flushing step 22 subsequently occurs. An etching in NaOH 30% occurs in the subsequent step 24. A flushing step (step 26) subsequently occurs.

A cleansing in HNO₃, i.e. an etching in nitric acid 1:1, occurs in step 28 after the alkaline etching. Because, depending on the material composition, brown to black etching slurry forms on the surface after the alkaline etching, it is subsequently cleansed in nitric acid in order to prevent the formation of AlO₃. A flushing step 30 subsequently occurs in turn. An electrically conductive layer is applied in step 32 in a zincate etching. The oxide layer on the aluminum material is also neutralized with the aid of this conductive layer. A flushing step 34 subsequently occurs.

FIG. 3 shows the subsequent flushing step 36 with de-mineralized water, i.e. de-ionized water, from which all minerals have been extracted in an ion exchanger. The surface is chemically pre-nickeled in the subsequent step 38. An inhibitor wash occurs in the subsequent step 40. A flushing in a reservoir without water feed occurs in the inhibitor wash, whereby the concentration in the wash increases. The content of the wash can then be fed back into the chemical nickel bath or be otherwise processed. Displacement losses are thus reduced. Cleansing in de-ionized water subsequently occurs in step 42.

The chemical deposition process subsequently occurs in step 44 with the nickel-copper-phosphor deposition that comprises a deposition of 1 to 2% copper, 8 to 10% phosphor and the remainder essentially a nickel deposition. Flushing in de-ionized water subsequently occurs in step 48. A watering in 60° C. water subsequently occurs in step 48, whereby the nickel-plated parts remain in de-ionized water 2-3 minutes before the drying. The finished casing is dried in hot air in the concluding step 50.

An example for a bath preparation for nickel-copper-phosphor deposition in step 44 is reproduced in the following, whereby the composition is specified in g/l:

nickel sulfate 30 g/l

copper sulfate 0.6-1.5 g/l

sodium hypophosphite 15 g/l

sodium citrate 50 g/l

ammonium chloride 40 g/l

pH value 9.0

temperature (° C.) 75

The casing so produced can be used as a transport casing for transport of a two-component toner mixture in development devices. The transport of toner can occur between rollers or also in the form of an applicator element in the immediate proximity of a photoconductor surface. Furthermore, such a casing can be used as a cleaning device.

Although a preferred exemplary embodiment is shown and described in detail in the drawings and in the preceding specification, it should be viewed as purely exemplary and not as limiting the invention. It is noted that only the preferred exemplary embodiment is are shown and described, and all variations and modifications should be protected that presently and in the future lie within the protective scope of the invention.

1-10. (canceled)

11. A casing for transport of a toner mixture on its outer surface in a development device, said casing having a wall substantially comprised of an electrically-conductive material, and an outer surface of the wall bearing a layer comprised of nickel-copper.

12. A casing accordance to claim 11 in which the layer is generated via chemical deposition.

13. A casing according to claim 12 wherein for said chemical deposition a chemical nickel-copper-phosphor deposition occurs.

14. A casing according to claim 11 in which a thickness of the layer lies in a range of 15-25 μm.

15. A casing according to claim 11 in which the wall of the casing is substantially comprised of aluminum.

16. A casing according to claim 11 in which the toner mixture comprises a two-component mixture which comprises ferromagnetic carrier particles and toner particles.

17. A method for production of a casing for transport of a toner mixture on its outer surface in a development device, comprising the steps of:
chemically pre-treating an outer surface of a metal casing; and
in subsequent chemical deposition generating a nickel-copper-phosphor layer on the outer surface of the metal casing, the layer comprising 1 to 2% copper and 8 to 10% phosphor and a remainder comprises substantially nickel.

18. A method according to claim 17 wherein said metal casing comprises aluminum on which a conductive layer is applied in a zincate etching after the chemical pre-treating, a chemical pre-nickeling occurs thereupon, and said chemical nickel-copper-phosphor deposition then subsequently occurs.

19. A method according to claim 17 in which a chemical bath which comprises nickel sulfate 30 g/l, copper sulfate 0.6 to 1.5 g/l, sodium hypophosphate 15 g/l, sodium citrate 50 g/l, and ammonium chloride 40 g/l is used for a chemical nickel-copper-phosphor deposition.

20. A method according to claim 19 in which the bath has a pH value of 9.0 and a temperature of 75° C.

21. A method for production of a casing for transport of a toner mixture on its outer surface in a development device, comprising the steps of:
chemically pre-treating an outer surface of a metal casing; and
in a subsequent chemical deposition generating a nickel-copper-phosphor layer on the outer metal casing surface, the layer comprising 1 to 2% copper and 8 to 10% phosphor and a remainder comprises substantially nickel.
